(19) United States
(12) Patent Application Publication
(10) Pub. No.: US 2003/0178790 A1
(43) Pub. Date: Sep. 25, 2003

(54) Shaft seal and process for manufacturing shaft seals

(76) Inventor: John Kapcoe, Bretten (DE)

Correspondence Address: Robert L. Stearns, 5291 Colony Drive North, Saginaw, MI, 48603, US

(21) Appl. No.: 10/366,254

(22) Filed: Feb. 13, 2003

(30) Foreign Application Priority Data
Feb. 28, 2002 (DE) 102 08 924.8

(51) Int. Cl. F16J 15/08

(52) U.S. Cl. 277/627; 264/259

(57) ABSTRACT

Process for manufacturing shaft seals, in which at least one PTFE washer equipped with hydrodynamic seals is arranged in working position with at least one stiffening member inside a die-casting machine. The stiffening member and the PTFE washer are at least partially coated with an elastomer. At least one zone that alters the cross-section of the PTFE washer is cast in the die-casting machine between the seals and the elastomer coating.

### BACKGROUND OF THE INVENTION

1. Technical Field

The invention concerns a shaft seal and a process for manufacturing shaft seals.

2. Related Art

U.S. Pat. No. 3,857,156 describes a shaft seal composed of two metallic stiffening members, a PTFE washer equipped with spiral-shaped hydrodynamic seals on the side facing the shaft, and a flat seal between one of the stiffening members and the PTFE washer. The components are positioned and rigidly joined with each other in a press, in such a way that the inner stiffening member is gripped in a cylindrical collar by the outer stiffening member. The disadvantage of this arrangement is that when the individual components are joined with each other, the PTFE washer, which consists of a gasket cut from a line, is bent at an appropriate angle so that the zone between the hydrodynamic seals and the stiffening member washers remains essentially invariant. But with this kind of fabrication it can happen that the seal's elasticity is insufficient, so that premature failure becomes likely.

U.S. Pat. No. 4,126,320 concerns a shaft seal consisting of a stiffening member with recesses and a PTFE washer equipped with hydrodynamic seals. The PTFE washer, which functions jointly with an arm of the stiffening member, is coated with an elastomer, such that, thanks to the recesses, an intimate bond is created between the components. The seal washer equipped with the hydrodynamic seals is pre-formed to an appropriately spiral shape in the mold so that, viewed in cross-section, the zone between the hydrodynamic seals and the elastomer-coated surface remains essentially invariant. But it can happen that, as a result of the preforming, the flexibility of the seal washer is not sufficient to guarantee durable sealing properties.

U.S. Pat. No. 4,243,235 describes a shaft seal, made of a composite material, whose sealing zone consists of a washer made of PTFE plus an elastomer. It may have hydrodynamic seals, as in the previously cited cases, which may be created by indenting the future sealing zone. The sealing zone is likewise of radial fabrication and may be reamed up using a taper plug and brought into its final position against the shaft. Excluding the hydrodynamic seals, the cross-section of the sealing zone remains invariant, as in the other cases.

The aim of the present invention is to offer a process for manufacturing and installing shaft seals using simpler technical means than are employed in the current state of the art. It is also aimed at offering a shaft seal that is capable of reacting more flexibly to radial forces.

### SUMMARY OF THE INVENTION

These aims are met by a process for manufacturing shaft seals whereby at least one PTFE washer equipped with indented hydrodynamic seals is arranged in working position with at least one stiffening member inside a die-casting machine, the stiffening member and the PTFE washer are at least partially coated with an elastomer, and at least one zone that alters the cross-section of the PTFE washer is cast in the die-casting machine between the seals and the elastomer-coating.

The aims of the invention are also met by a shaft seal comprising at least one stiffening member, at least one PTFE washer equipped with indented hydrodynamic seals, and an elastomer body that at least partially surrounds the stiffening member and the PTFE washer while at the same time a zone extending radially from the back of the seals in the direction of the elastomer body alters the cross-section of the PTFE washer.

The shaft seal and the manufacturing process proposed by the invention insert a radial zone of defined flexibility between the hydrodynamic seals and the elastomer body, so that the PTFE washer, especially its sealing zone, is capable of reacting more flexibly, as regards the pressure it exerts against the shaft. By appropriate modification of the zone whose cross-section is altered, especially as to depth of profiling, differentiated elasticity can be introduced by making the zone adjacent to the hydrodynamic seal-equipped sealing zone correspondingly flexible.

By introducing at least one circumferential groove, the elastomer can be prevented from penetrating into the zone of the hydrodynamic seals during the die-casting process, and from thereby disabling the seals by clogging them up. The same naturally applies for other profiles such as coil-like threading or the like.

It will be more advantageous to fabricate the flexible radial zone of the PTFE washer by stamping inside the die-casting tool. The hydrodynamic seals can be introduced into the sealing zone in a manner analogous to the state of the art.

### THE DRAWINGS

Exemplary embodiments of the invention are illustrated in the drawings and described below wherein:

FIG. 1 shows the preparation of a PTFE washer and a stiffening member for use in fabricating a shaft seal;

FIG. 2 shows a finished shaft seal following its extraction from a die-cast mold:

FIGS. 3 and 4 show alternative embodiments of a shaft seal; and

FIGS. 5 and 6 present the shaft seal shown in FIG. 3 respectively as it appears following extraction from a die-cast mold and as it appears in the installed position, respectively.

### DETAILED DESCRIPTION

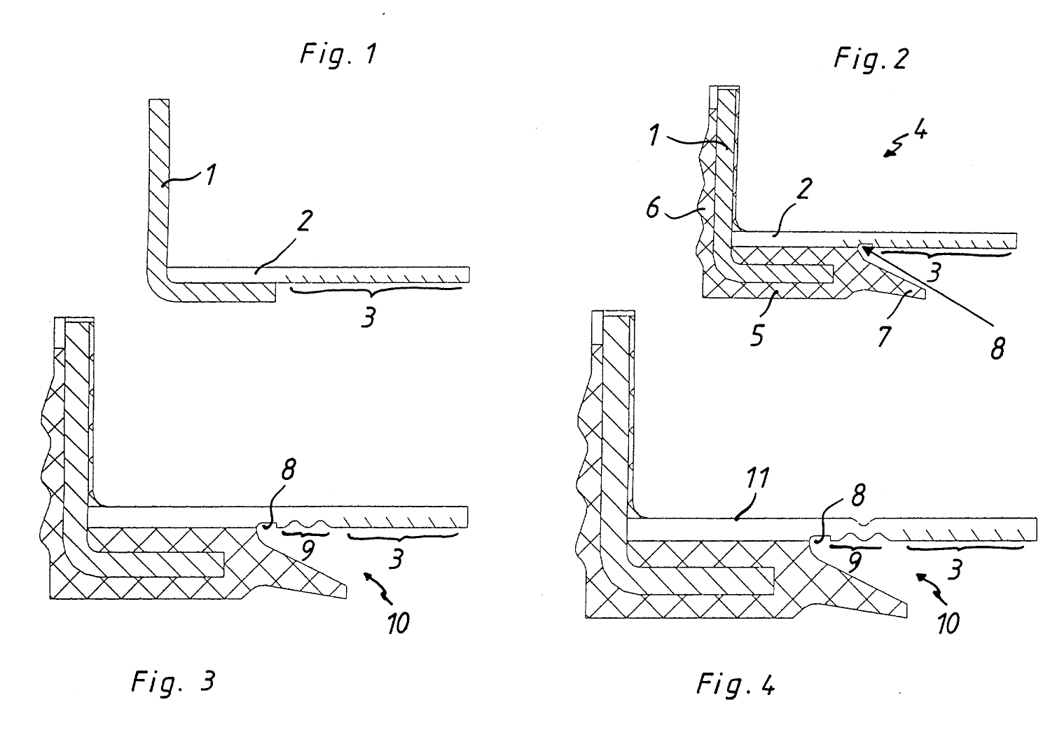

FIG. 1 shows a washer-shaped stiffening member 1 and a washer 2 made of PTFE arranged in working position before being placed inside a die-casting mold (not shown). The PTFE washer 2 can be equipped with indented hydrodynamic seals 3 in a manner analogous to the state of the art (e.g. U.S. Pat. No. 3,587,156) using a tool. There is no rigid connection between the stiffening member 1 and the PTFE washer 2 in this position. The two components are placed together inside a die-casting mold, but it is also conceivable that these components 1 and 2 could be placed in the die-casting mold one at a time.

FIG. 2 shows the finished shaft seal 4 after extraction from the mold. The stiffening member 1 can be discerned along with the PTFE washer 2, both being partially coated with elastomer 5. Zone 6 of the shaft seal 4 is a static seal, while zone 7 is a supplementary seal washer. The arrow points to a circumferential groove 8 which, inside the die-casting mold, prevents the elastomer 5 from reaching the zone of the hydrodynamic seals 3 during the die-casting process. This zone 8 itself alters the cross-section of the PTFE washer 2 axially, as a result of which the pressure exerted by the hydrodynamic seals 3 against the shaft after the seal 4 has been put in place can be made flexible.

FIGS. 3 and 4 show further ways of altering the cross-section of PTFE washer 2 so as to create radial zone 9, which contributes further to elasticizing the pressure exerted in the installed position. Here too the circumferential groove 8 can be discerned. The zones numbered 9 take the form of coil-like threading in one or both frontal zones 10 and 11; they are created by stamping inside the die-casting tool.

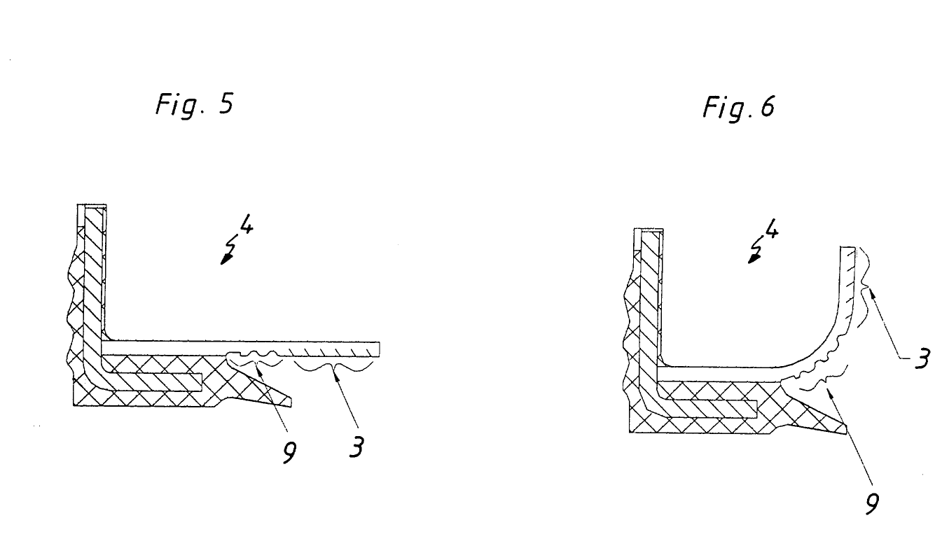

FIGS. 5 and 6 show the finished shaft seal 4, respectively as it appears following extraction from the mold and as it appears in the indicated installed position. The hydrodynamic seals 3 are discernible, as is the elastic radial zone 9; the hydrodynamic seals 3, as shown in FIG. 6, are mounted against a shaft that is not shown here.

Obviously, many modifications and variations of the present invention are possible in light of the above teachings. It is, therefore, to be understood that within the scope of the appended claims, the invention may be practiced otherwise than as specifically described. The invention is defined by the claims.

What is claimed is:

1. Process for manufacturing shaft seals, in which at least one PTFE washer equipped with hydrodynamic seals is arranged in working position with at least one stiffening member inside a die-casting machine, the stiffening member and the PTFE washer being at least partially coated with an elastomer, and wherein at least one zone that alters the cross-section of the PTFE washer is formed in the die-casting machine between the seals and the elastomer coating.

2. Process as in claim 1 wherein the at least one zone is formed by stamping the zone inside the die-casting machine.

3. Process as in claim 1 wherein the at least one zone is formed in the shape of a circumferential groove of predetermined depth.

4. Process as in claim 1 wherein the at least one zone is formed in the shape of a spiral threading of predetermined depth.

5. Process as in claim 1 wherein the cross-sectional alteration of the PTFE washer is made to two frontal surfaces of the PTFE washer.

6. Shaft seal, comprising at least one stiffening member, at least one PTFE washer equipped with hydrodynamic seals, and an elastomer body at least partially surrounding the stiffening member and the PTFE washer, wherein at least one zone that alters the cross-section of the PTFE washer extends radially from a back of the hydrodynamic seals in the direction of the elastomer body.

7. Shaft seal as in claim 6 wherein the at least one zone takes the form of at least one circumferential groove in the plane of the hydrodynamic seals.

8. Shaft seal as in claim 6 wherein the at least one zone takes the form of a spiral threading in the plane of the hydrodynamic seals.

9. Shaft seal as in claim 6, including members altering the profile of the PTFE washer provided on two axial frontal surfaces of the PTFE washer.

10. Shaft seal as in claim 6 wherein the depth of the at least one zone varies in depth.
